(19) United States
(12) Patent Application Publication
(10) Pub. No.: US 2025/0067468 A1
(43) Pub. Date: Feb. 27, 2025

(54) ELECTRIC PROCESS HEATER WITH HIGHER FLUX HEATING ELEMENTS IN ZONES OF PERPENDICULAR FLOW

(71) Applicant: Thermon Canada Inc., Edmonton (CA)

(72) Inventors: David TENEYCKE, Oakville (CA); Simon CHANG, Ancaster (CA); David JOHNSTON, Edmonton (CA); Paul MOORS, Edmonton (CN)

(21) Appl. No.: 18/948,104

(22) Filed: Nov. 14, 2024

Related U.S. Application Data
(63) Continuation-in-part of application No. 18/362,965, filed on Aug. 1, 2023.

(30) Foreign Application Priority Data
Aug. 21, 2024 (CA) 3244836

(51) Int. Cl. F24H 1/10; F24H 9/00; H05B 3/42

(52) U.S. Cl. CPC F24H 1/102; F24H 9/0015; H05B 3/42; F24H 2250/02; H05B 2203/007; H05B 2203/037

(57) ABSTRACT

An electric process heater has a vessel containing a fluid and a plurality of elongated heating elements extending inside the vessel parallel to a central axis of the electric process heater. The plurality of elongated heating elements includes a first subset of elongated heating elements having a higher surface flux than a second subset of elongated heating elements. The electric process heater includes baffles to redirect a flow of the fluid over the elongated heating elements to improve heat transfer. The flow includes a parallel flow zone of parallel flow where the fluid flows parallel to the elongated heating elements and a crossflow zone of perpendicular flow where the fluid flows perpendicularly to the elongated heating elements. The first subset of elongated heating elements having the higher surface flux is disposed in the crossflow zone and the second subset of elongated heating elements is disposed in the parallel flow zone.

### CROSS-REFERENCE TO RELATED APPLICATIONS

This application is a continuation-in-part of and claims the right of priority to U.S. patent application Ser. No. 18/362,965, filed Aug. 1, 2023, and further claims priority to Canadian Patent Application No. 3,244,836, filed on Aug. 21, 2024, the disclosures both of which are hereby incorporated by reference herein in their entireties for all purposes.

### TECHNICAL FIELD

The present invention relates to electric process heaters and more particular to electric process heaters that have baffles.

### BACKGROUND

Electric process heaters have been used for many years in various industries. The design of many process heaters typically involves the use of tubular metal-sheathed heating elements formed into a hairpin shape in which one or more heating elements are arranged in a heating bundle and placed inside a fluid-containment piping system. Although many such designs are known in the art, there remains a need in the industry to improve the effective heat transfer rate of heat produced by the electric heater to the fluid being heated. Many electric process heaters use baffles to redirect the flow of fluid (liquid or gas) over the heating elements to provide improved heat transfer between the heating element and the fluid. Further improvements to enhance heat transfer efficiency remain highly desirable.

### SUMMARY

The following presents a simplified summary of some aspects or embodiments of the invention in order to provide a basic understanding of the invention. This summary is not an extensive overview of the invention. It is not intended to identify key or critical elements of the invention or to delineate the scope of the invention. Its sole purpose is to present some embodiments of the invention in a simplified form as a prelude to the more detailed description that is presented later.

The present specification discloses an electric process heater comprising a vessel containing a heat-transfer fluid and a plurality of elongated heating elements extending inside the vessel parallel to a central axis of the electric process heater. The plurality of elongated heating elements comprises a first subset of elongated heating elements having a higher surface flux than a second subset of elongated heating elements. The electric process heater includes a plurality of baffles disposed at axial intervals inside the electric process heater to redirect a flow of the fluid over the elongated heating elements to provide improved heat transfer between the elongated heating elements and the fluid inside the vessel. The flow comprises a parallel flow zone of parallel flow where the fluid flows parallel to the elongated heating elements and a crossflow zone of perpendicular flow where the fluid flows perpendicularly to the elongated heating elements. The first subset of elongated heating elements having the higher surface flux is disposed in the crossflow zone and the second subset of elongated heating elements is disposed in the parallel flow zone.

The present specification also discloses an electric process heater comprising a vessel containing a heat-transfer fluid and a plurality of elongated heating elements extending inside the vessel. The plurality of elongated heating elements comprises a first subset of elongated heating elements having a higher surface flux than a second subset of elongated heating elements. The electric process heater includes a plurality of baffles disposed inside the electric process heater and having holes through which the elongated heating elements extend. The heat-transfer fluid flows in a longitudinal flow zone where the fluid flows along the elongated heating elements and in a crossflow zone where the fluid flows between adjacent baffles across the elongated heating elements. The first subset of elongated heating elements is disposed in the crossflow zone and the second subset of elongated heating elements is disposed in the longitudinal flow zone.

The present specification further discloses an electric process heater comprising a vessel containing a heat-transfer fluid and a plurality of elongated heating elements extending inside the vessel. The plurality of elongated heating elements comprises higher surface flux heating elements and lower surface flux heating elements. The electric process heater includes a plurality of baffles disposed inside the electric process heater and having holes through which the elongated heating elements extend. The heat-transfer fluid flows in a longitudinal flow zone where the fluid flows along the elongated heating elements and in a crossflow zone where the fluid flows between adjacent baffles across the elongated heating elements. The higher surface flux heating elements are disposed in the crossflow zone and the lower surface flux heating elements are disposed in the longitudinal flow zone.

### BRIEF DESCRIPTION OF THE DRAWINGS

These and other features of the disclosure will become more apparent from the description in which reference is made to the following appended drawings.

FIG. 1 is a schematic side view of an electric process heater having a plurality of no-tube-in-window baffles in accordance with an embodiment of the present invention.

FIG. 2 is a schematic side view of an electric process heater having a plurality of stepped segmental baffles in accordance with an embodiment of the present invention.

FIG. 3 is a perspective view of a plurality of no-tube-in-window baffles that may be used in the electric process heater in accordance with another embodiment of the present invention.

FIG. 4 is a perspective view of stepped segmental baffles that may be used in the electric process heater in accordance with an embodiment of the present invention.

FIG. 5 is another perspective view of stepped segmental baffles.

FIG. 6 is an end view a stepped segmental baffle.

FIG. 7 is another perspective view of stepped segmental baffles.

FIG. 8 is another perspective view of stepped segmental baffles.

FIG. 9 is an enlarged view of a flow-through heating element support hole of a baffle in accordance with an embodiment of the present invention.

FIG. 10 is an enlarged view of a flow-through heating element support hole of a baffle showing the gap at the interface between the baffle and the heating element.

FIG. 11 is an enlarged view of a heating element having fins in accordance with an embodiment of the present invention.

FIG. 12 is a schematic side view of an electric process heater in which the elongated heating elements in a crossflow zone have higher surface flux than the elongated heating elements in a parallel flow zone in accordance with an embodiment of the present invention.

FIG. 13 is a schematic side view of an electric process heater showing the crossflow between baffles in the crossflow zone and the parallel flow in the parallel flow zone.

FIG. 14 is a schematic depiction of an electric process heater having three different types of elongated heating elements having three different surface fluxes.

FIG. 15 is a depiction of an electric process heater in which the first subset of elongated heating elements is made of a first material and the second subset of elongated heating elements is made of a second material having a different resistivity than the first material.

FIG. 16 is a depiction of an electric process heater in which the first subset of elongated heating elements has a first wire gauge and the second subset of elongated heating elements has a second wire gauge.

FIG. 17 is a depiction of an electric process heater in which the first subset of elongated heating elements has a first coil pitch and the second subset of elongated heating elements has a second coil pitch.

FIG. 18 is a depiction of an electric process heater in which at least one of the elongated heating elements has segments made of different materials having different surface fluxes.

FIG. 19 is a depiction of an electric process heater in which at least one of the elongated heating elements has segments having different wire gauges that generate different surface fluxes.

FIG. 20 is a depiction of an electric process heater in which one of the elongated heating elements has segments having different coil pitches that generate different surface fluxes.

FIG. 21 is a depiction of an electric process heater in which one of the elongated heating elements has a segment having a tapered wire gauge providing a variable surface flux.

### DETAILED DESCRIPTION OF EMBODIMENTS

The following detailed description contains, for the purposes of explanation, numerous specific embodiments, implementations, examples and details in order to provide a thorough understanding of the invention. It is apparent, however, that the embodiments may be practiced without these specific details or with an equivalent arrangement. In other instances, some well-known structures and devices are shown in block diagram form in order to avoid unnecessarily obscuring the embodiments of the invention. The description should in no way be limited to the illustrative implementations, drawings, and techniques illustrated below, including the exemplary designs and implementations illustrated and described herein, but may be modified within the scope of the appended claims along with their full scope of equivalents.

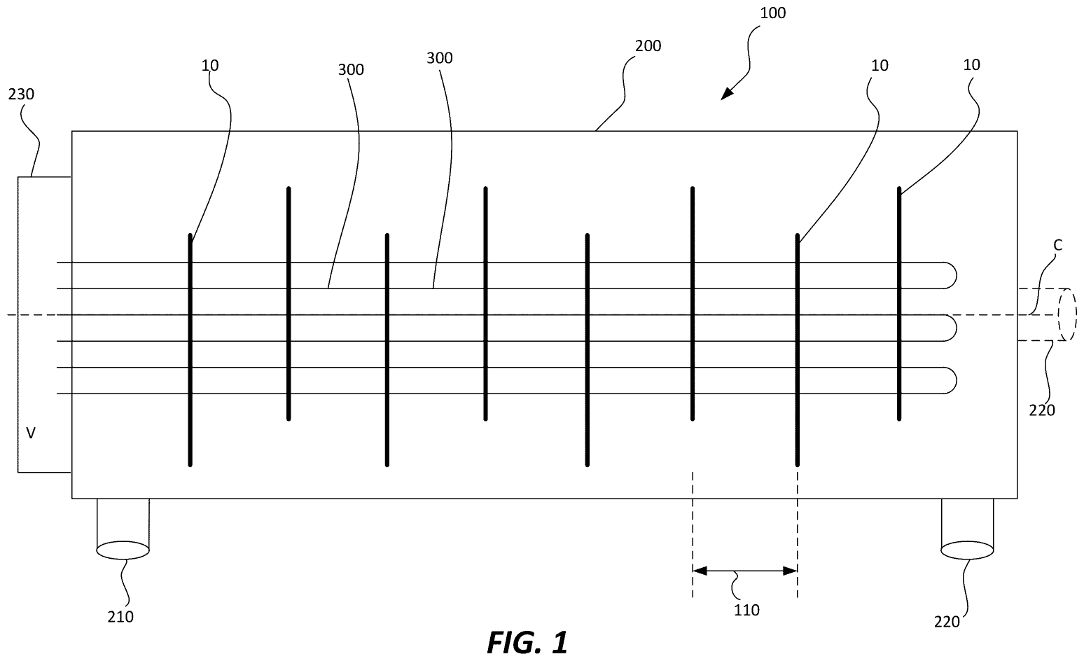

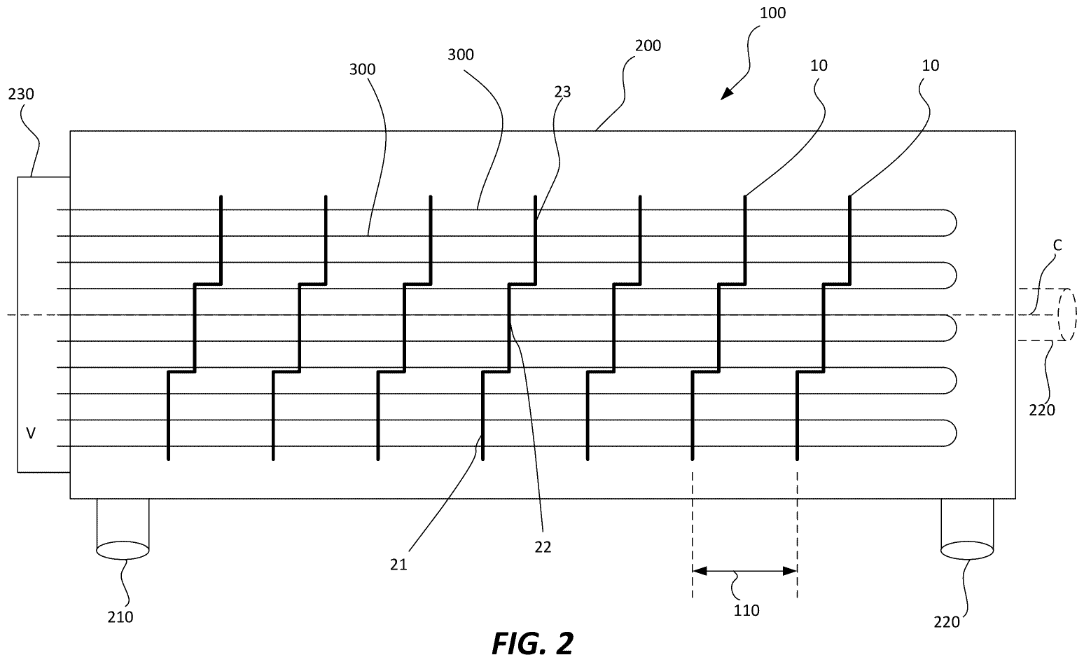

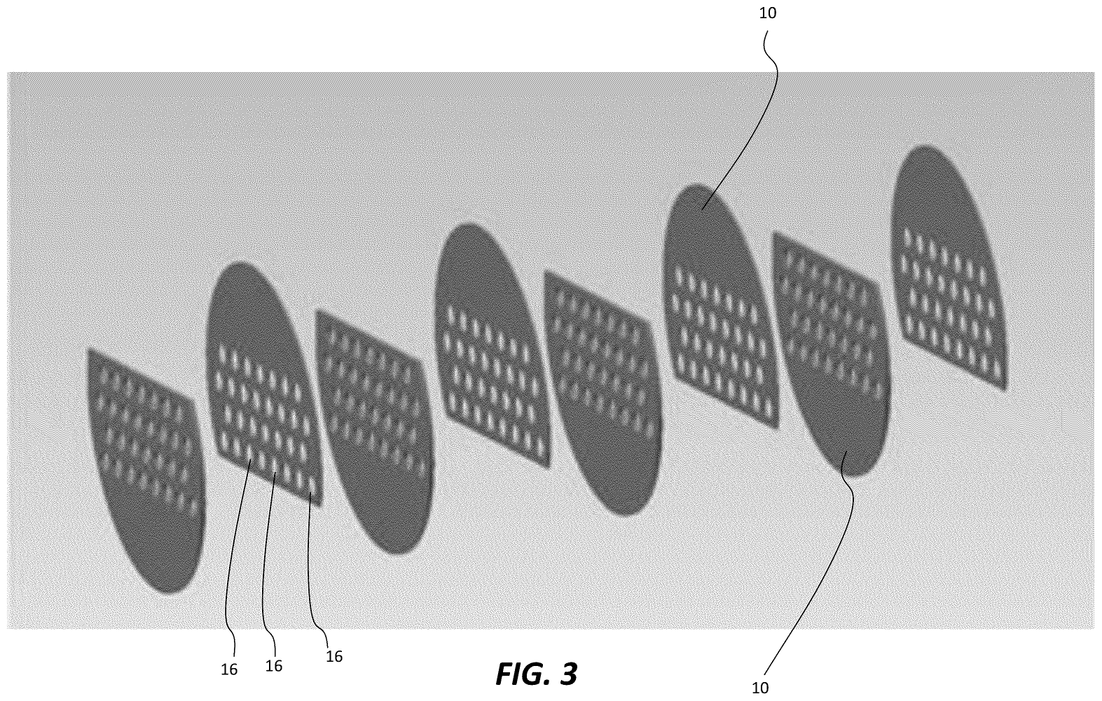

FIG. 1 is a schematic side view of an electric process heater having a plurality of no-tube-in-window baffles in accordance with an embodiment of the present invention. The electric process heater includes a heat exchanger in which the baffles act to redirect the flow of fluid over the heating elements to provide improved heat transfer between the heating elements and the fluid. FIG. 2 is a similar schematic side view of the electric process heater in which the baffles are stepped segmental baffles in accordance with a more specific embodiment of the present invention. In another embodiment, the electric process heater includes no-tube-in-window (NTIW) baffles 10 as shown in FIGS. 1 and 3. The NTIW baffles 10 of FIG. 3 have a plurality of holes (or perforations) 16 through which elongated heating elements extend. The electric process heater may incorporate other types of baffles like disk-and-donut baffles, segmental baffles, spiral baffles, and helical baffles. As will be described below, in various embodiments of the present invention, the electric process heater has baffles that include flow-through heating element holes that permit the fluid inside the heater to flow at an interface of the baffle and heating element to prevent localized overheating. The heating elements may also have fins.

In the embodiment depicted by way of example in FIG. 1, an electric process heater denoted generally by reference numeral 100 includes a fluid-containment vessel 200 containing a fluid and a plurality of elongated heating elements 300 extending inside the vessel parallel to a central axis C of the electric process heater that loop back in a hairpin arrangement as shown. The vessel 200 has a fluid inlet 210 and a fluid outlet 220. The fluid inlet 210 may be disposed on the side of the vessel as shown. Likewise, the fluid outlet 220 may be disposed on the side of the vessel. Alternatively, the fluid outlet 220 may be disposed on the end of the vessel as shown in dashed lines in FIGS. 1 and 2. It is also possible to reverse the fluid inlet and fluid outlet so that the fluid flows in the opposite direction. The electric process heater 100 also has a wiring junction box denoted by reference numeral 230. In the embodiments of FIGS. 1 and 2, all of the heating element connections are disposed at one end and extend through a piping flange attached to the vessel into the wiring junction box 230 to simplify electrical connections of the heating elements. The vessel 200 may alternatively be a closed tank without the fluid inlet and fluid outlet. The elongated heating elements 300 may be electrical heating elements, i.e. electrically resistive heating elements that generate heat when electric current flows through a resistor, wire, ribbon, or equivalent. Any suitable electrically resistive wire, ribbon or material may be used for the electric heating element such as, for example, nickel-chrome alloy or any functionally equivalent material capable of generating heat by resistance. In the illustrated embodiment, a voltage source V (or power source), which may be incorporated in the junction box 230, generates the electric current for the electrical heating elements. The electric process heater includes a plurality of baffles 10, e.g. no-tube-in-window baffles, disposed at axial intervals 110 inside the electric process heater to redirect the flow of fluid over the heating elements to provide improved heat transfer between the heating elements and the fluid.

The electric process heater 100 may be an immersion-type heater in which the heating elements are immersed in a fluid to be heated. The electric process heater may also be used or adapted for use in other types of heaters such as flange heaters, pressurized heaters, circulation heaters, etc. The electric process heater may be used in various heating applications for heating a fluid (liquid or gas) for various purposes such as, for example, temperature regulation, freeze protection, vaporization/boiling, stabilizing a condensate, reducing viscosity of a liquid, etc.

FIG. 2 depicts the electric process heater 100 in which the baffles are stepped segmental baffles 10. As described below, stepped segmental baffles provide particularly superior performance and are easier to manufacture than helical or spiral baffles. Alternatively, in another embodiment that also provides excellent performance, a plurality of no-tube-in-window baffles 10 may be used in the electric process heater. FIG. 3 shows a plurality of no-tube-in-window (NTIW) baffles 10 having holes 16. Other configurations of NTIW baffles may be used with different numbers or patterns of holes to accommodate different number or arrangements of heating elements.

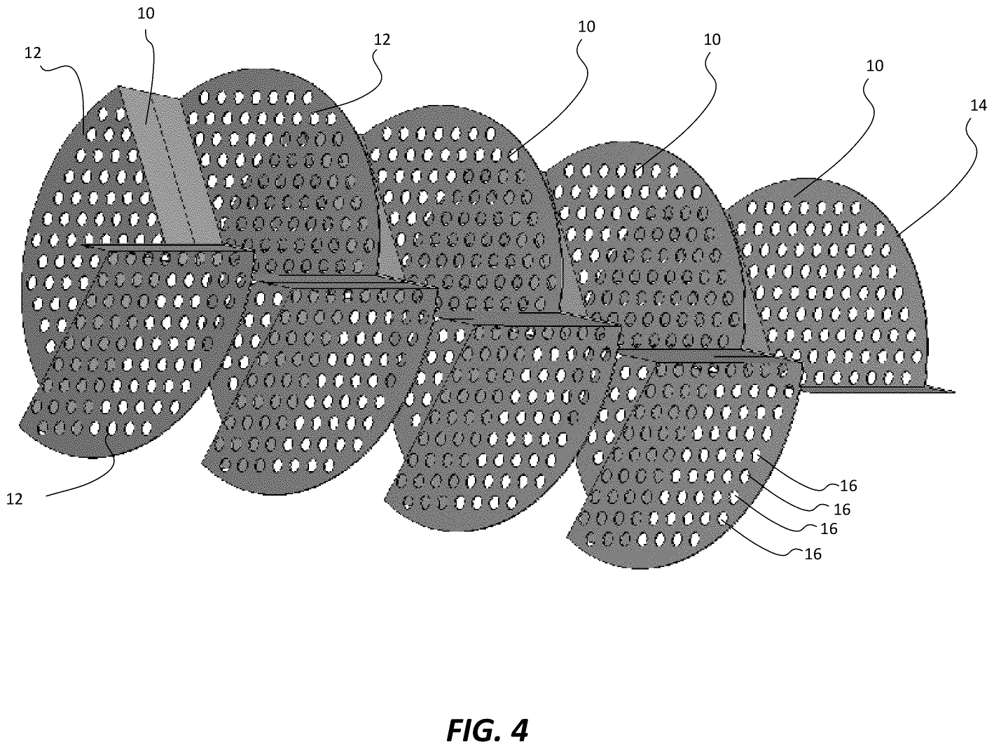

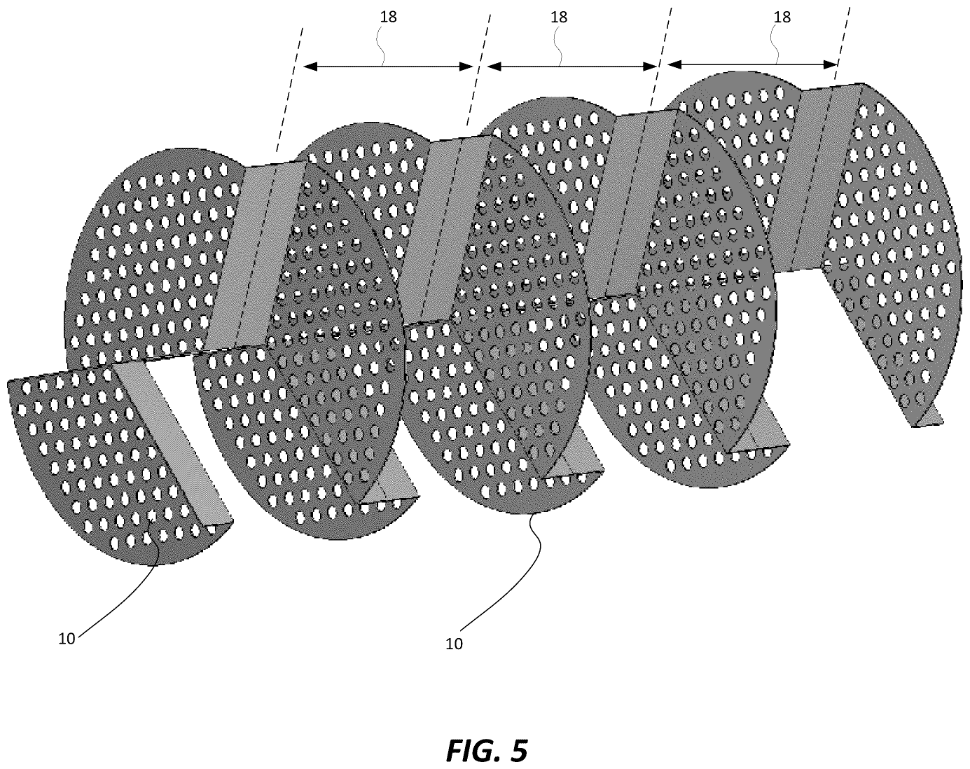

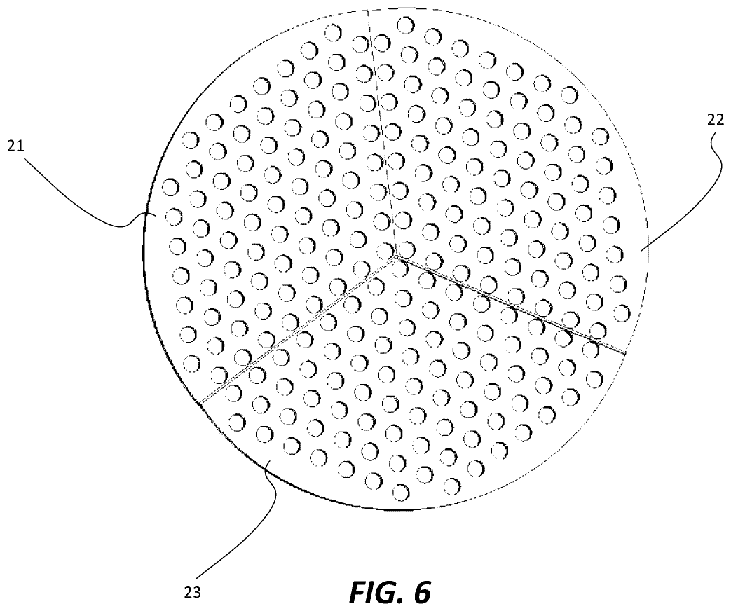

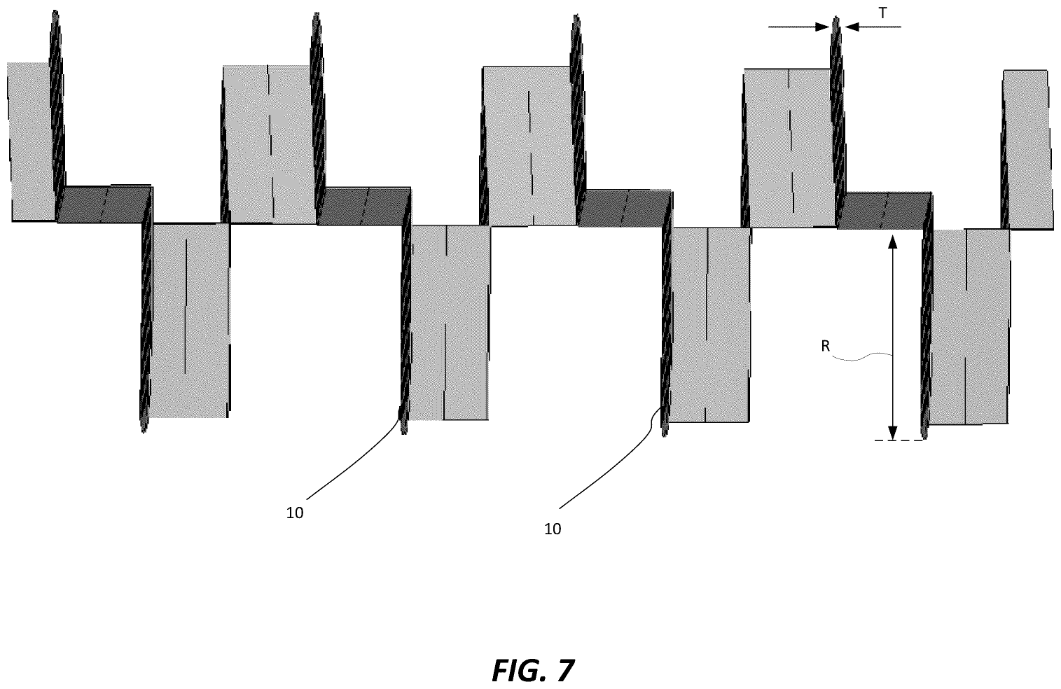

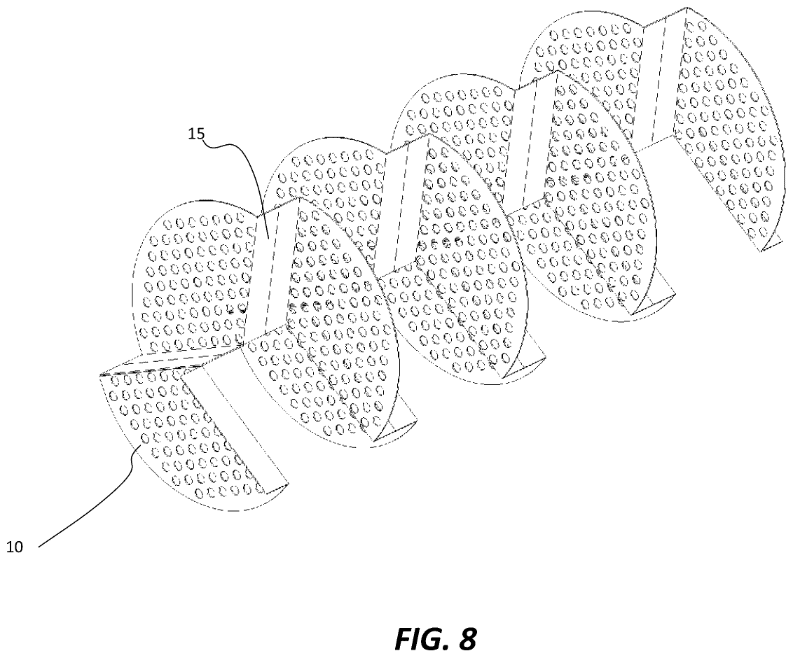

FIGS. 4 to 8 are views of a stepped segmented baffle that may be used advantageously in the electric process heater 100 of FIG. 2 in accordance with a particular embodiment of the present invention.

As shown by way of example in FIGS. 4 to 8, the stepped segmental baffle 10 has a plurality of stepped segments 12 defined by a flat structure 14 that includes a plurality of perforations 16 through which elongated heating elements extend as depicted by way of example in the schematic illustration of an electric process heater in FIG. 2. In the embodiment illustrated in these figures, the stepped segments 12 are disposed orthogonally relative to a central axis C of the electric process heater. The stepped segments 12 are spaced apart from each other by an axial distance 18. As such, the stepped segments 12 are parallel to each other. The stepped segments 12 are supported by perpendicularly disposed segment support 15 which define surfaces that are orthogonal to the stepped segments 12 as shown in the figures.

In one specific embodiment, illustrated by way of example in FIGS. 4 to 8, the stepped segmented baffle 10 has a first stepped segment 21, a second stepped segment 22 and a third stepped segment 23. In another embodiment, the baffle 10 may have more than three stepped segments, e.g. four stepped segments, five stepped segments, six stepped segments, etc.

In one specific embodiment, illustrated by way of example in the figures, the first stepped segment 21, the second stepped segment 22 and the third stepped segment 23 have identical shapes.

In one specific embodiment, illustrated by way of example in the figures, the first stepped segment 21, the second stepped segment 22 and the third stepped segment 23 each define 120-degree sectors. When viewed from the end, therefore, the baffle covers 360 degrees. In another embodiment having four stepped segments, each sector would define 90-degree sectors. In another embodiment having five stepped segments, each sector would define 72-degree sectors. In another embodiment having six stepped segments, each sector would define 60-degree sectors. More than six sectors is also possible in other variants. In these embodiments, each sector is identical; however, in yet further embodiments, the sectors may be different (unequal) in size and/or angular span. In the embodiments described so far, the segments of a given baffle cover 360 degrees as noted above; however, in other embodiments, it may be possible to have segments that cover more than 360 degrees or less than 360 degrees.

In one specific embodiment, illustrated by way of example in FIGS. 4 to 8, the stepped segments 12 extend radially outward from the central axis C by a radial distance R greater than the axial distance. In the illustrated embodiment, the radial distance R of each segment is the same; however, in other embodiments, it may be possible to have segments of different radius, e.g. different radii R1, R2, R3.

In the embodiment illustrated by way of example in FIGS. 4 to 8, a thickness T of each one of the stepped segments is less than the axial distance.

In one specific embodiment, illustrated by way of example in the figures, the first stepped segment 21, the second stepped segment 22 and the third stepped segment 23 have the same number of perforations 16. Such an arrangement provides radial symmetry for the bundle(s) of heating elements inside the vessel. In another embodiment, however, it may be useful for some specific reason or application to provide a different number of perforations 16 on each segment. Similarly, as shown in the figures, the perforations 16 are all the same size (same diameter) in order to accommodate heating elements having a uniform diameter.

In one specific embodiment, illustrated by way of example in the figures, the axial distance between the first segment 21 and the second segment 22 is the same as the axial distance between the second segment 22 and the third segment 23. In another embodiment, the axial distance may be different. The stepped segmental baffle 10 can be made with varying axial distance (pitch) between the steps of the baffle to optimize the heater performance.

The stepped segmented baffle 10 may be manufactured, for example, by separately making each of the segments 12 and then joining the segments together to form the baffle. The stepped segmented baffle is thus easier and less expensive to manufacture than a spiral baffle or a helical baffle. The stepped baffle design with segments being orthogonal to the central axis provides excellent flow characteristics that in turn improve the heat transfer efficiency of the heater.

The baffles 10 may also be used in another type of heat exchanger such as a fluid-to-fluid heater or heat exchanger in which the heating elements are fluid-carrying tubes instead of electric heating elements. In other words, the baffles 10 may be used, or adapted for use, in other types of heat exchangers such as shell-and-tube heat exchanger in which a first fluid is carried through tubes inside a shell (vessel). The tubes extend through holes in baffles to exchange heat with a surrounding second fluid. It will be appreciated that this novel baffle design may find applications and uses in various other types of heat exchangers.

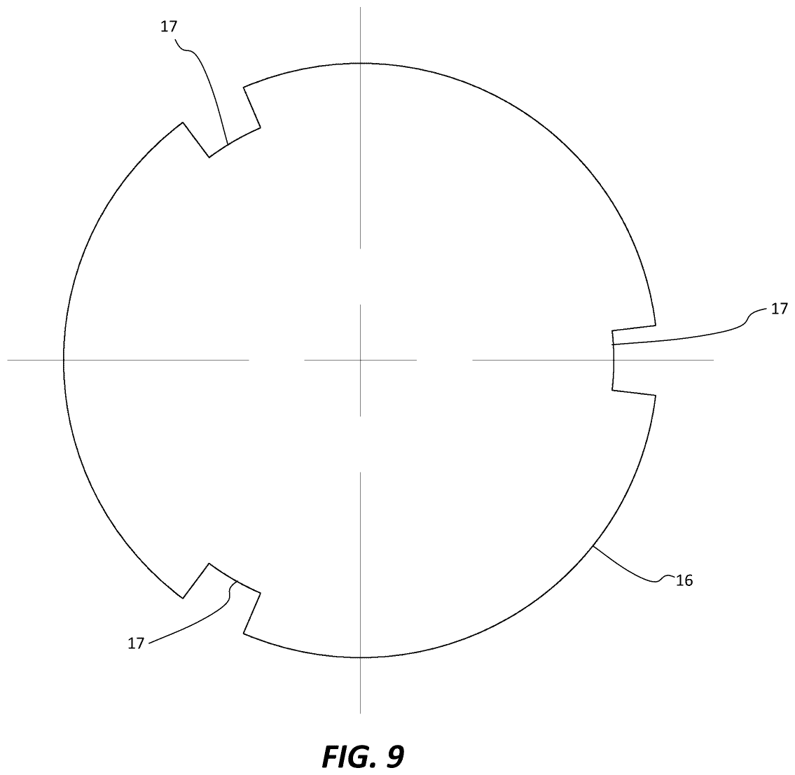

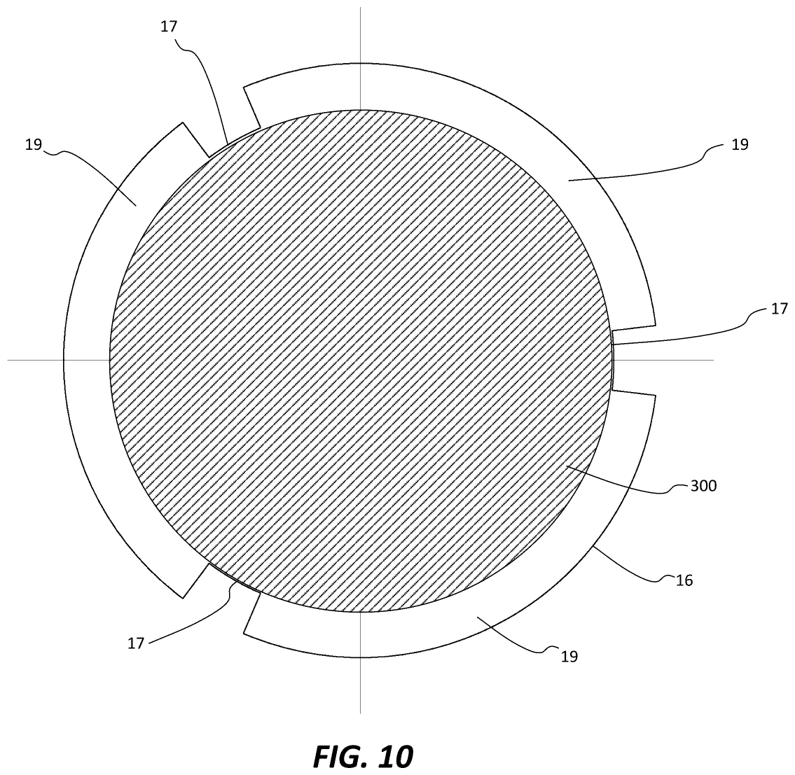

FIG. 9 is an enlarged view of a flow-through heating element support hole 16 of a baffle in accordance with an embodiment of the present invention. As described and illustrated, each baffle has a plurality of such holes 16 designed to receive and support the elongated heating elements. The holes 16 of each baffle are aligned with the holes of the other baffles so that the elongated heating elements can fit straight through these holes. The novel flow-through heating element support hole 16 receives and supports the elongated heating elements while providing a flow-through design for fluid to cool the interface of the heating element and baffle in order to prevent localized hot spots. Each of the plurality of flow-through heating element support holes 16 as shown in FIGS. 9 and 10 has a plurality of element-contacting tabs 17 that protrude radially inwardly to support the heating elements 300 within the baffles 10. The tabs 17 define a plurality of gaps 19 through which the fluid flows between the baffles 10 and the heating elements 300 to reduce a thermal differential at a heating element-baffle interface FIG. 9 shows the hole 16 in isolation. FIG. 10 is an enlarged view of the flow-through heating element support hole 16 with the heating element 300 inside, showing the gap 19 at the interface between the baffle and the heating element 300. The gap enable fluid to flow along the surface where the baffle meets the heating element (referred to herein as the heating element-baffle interface). The fluid flow cools the interface, preventing localized overheating and thus extending the life span of the electric process heater.

In one embodiment each of the flow-through heating element support holes 16 comprises three equally spaced tabs. In another embodiment, there may be 2 tabs, 4 tabs, 5 tabs or another number of tabs. In the illustrated embodiment, the tabs 17 define an angular arc that is less than an angular arc defined by each of the gaps 19. In another embodiment, the gaps may span an equal or smaller angular arc than the tabs. In the illustrated embodiment, the tabs are equal in size and shape. In another embodiment, the tabs may be different sizes and/or different shapes to accommodate for example a non-circular or asymmetrical heating element. In a main embodiment, the tabs are made of the same material as the rest of the baffle. In another embodiment, the tabs may be made of a different material. The tabs may have the same thickness as the rest of the baffle although in a variant the tabs may have a different thickness. In most embodiments, each hole 16 of each baffle is a flow-through heating element support hole; however, it is possible in some other embodiments that only a subset of the holes 16 are flow-through heating element support holes.

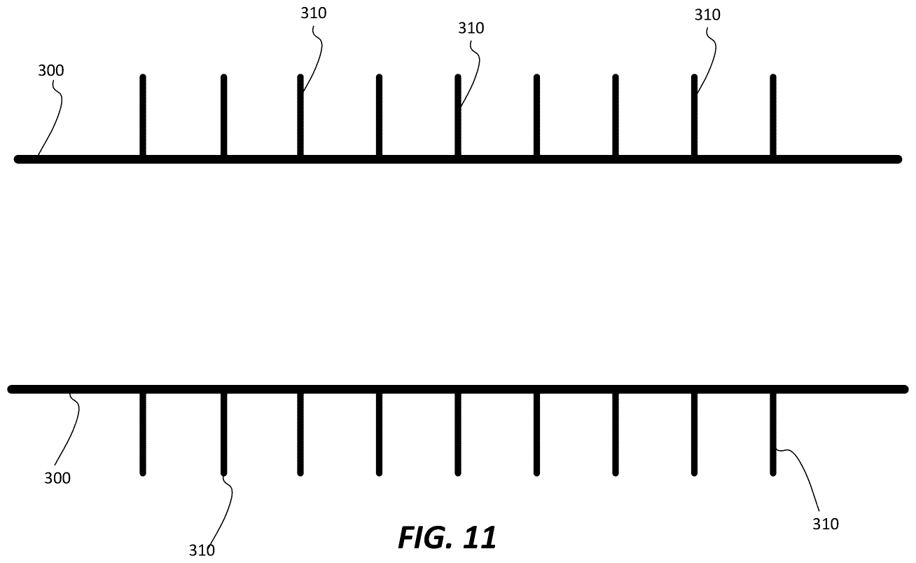

In one embodiment, the heating elements 300 have fins 310. The fins may extend over substantially all of the length of the heating elements or only over portions of the heating elements. FIG. 11 is an enlarged view of a segment of a heating element 300 having fins 310 in accordance with an embodiment of the present invention. The fins 310 may be of equal size and shape or they may be of differing size and shape. Likewise, the spacing between fins may be constant or varying.

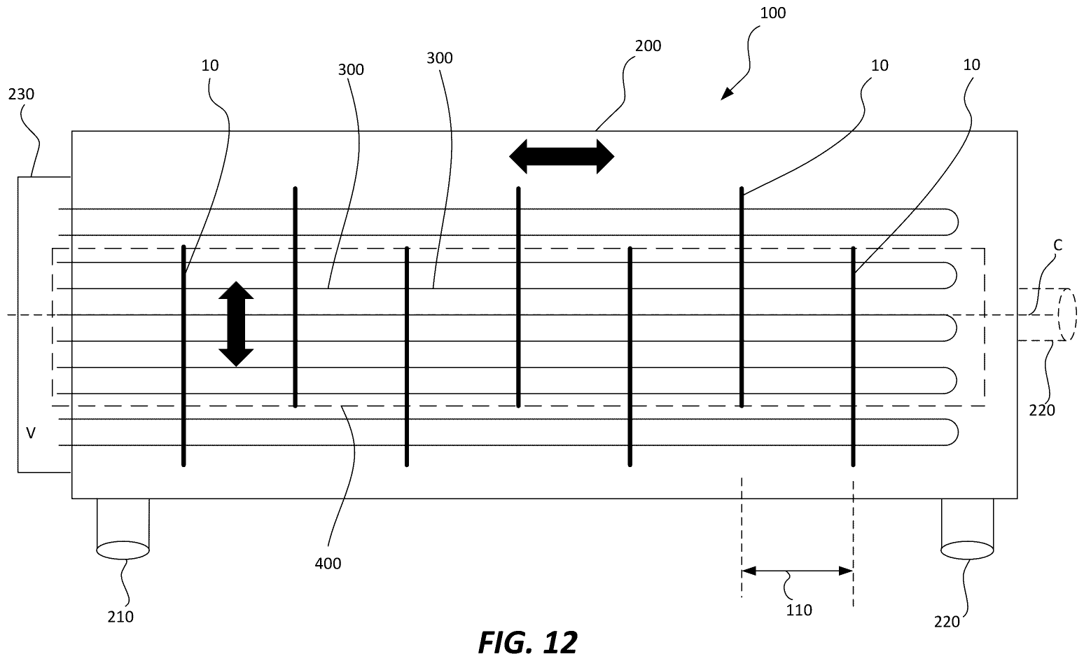

FIGS. 12-21 depict further inventive aspects of the present disclosure. In these further inventive aspects, as depicted by way of example in FIG. 12-21, the electric process heater 100 includes elongated heating elements 300 that provide different surface flux (watt density) for parallel flow and crossflow zones of the vessel 200. This innovation enhances the overall heat transfer efficiency of the electric process heater and enables the design of more compact electric process heaters.

In the embodiment depicted in FIG. 12, the electric process heater 100 has a vessel 200 containing a heat-transfer fluid and a plurality of elongated heating elements 300 extending inside the vessel parallel to a central axis C of the electric process heater. In the embodiment of FIG. 12, the plurality of elongated heating elements 300 comprise a first subset of elongated heating elements having a higher surface flux than a second subset of elongated heating elements. The first subset of elongated heating elements includes those heating elements that are disposed inside the dashed-line rectangle 400 shown in FIG. 12 whereas the second subset of elongated heating elements includes those heating elements that are disposed outside the dashed-line rectangle 400. The electric process heater 100 includes, as shown in FIG. 12, a plurality of baffles 10 disposed at axial intervals 110 inside the electric process heater to redirect a flow of the fluid over the elongated heating elements to provide improved heat transfer between the elongated heating elements and the fluid inside the vessel. The axial intervals (spacing) between adjacent baffles may be equal as shown or they may be unequal in a variant. The flow of fluid inside the vessel comprises a parallel flow zone of parallel flow (the zone outside rectangle 400 in FIG. 12) where the fluid flows parallel to the elongated heating elements and a crossflow zone of perpendicular flow (i.e. the zone inside the rectangle 400) where the fluid flows perpendicularly to the elongated heating elements. The first subset of elongated heating elements (having the higher surface flux) is disposed in the crossflow zone (i.e. inside rectangle 400) and the second subset of elongated heating elements is disposed in the parallel flow zone (i.e. outside rectangle 400).

In some embodiments, the vessel 200 is a cylindrically shaped shell, the baffles 10 have a generally circular profile, and the elongated heating elements 300 form a bundle of equidistantly spaced-apart heating elements extending through respective holes in the baffles. In these embodiments, as depicted in FIG. 12, the crossflow zone is an inner cylindrical zone and the parallel flow zone is an outer annular zone that is concentrically disposed around the crossflow zone. It will be appreciated that, if the vessel were a different shape, the same concept could be readily applied by providing the higher surface flux elements in crossflow zones and lower surface flux elements in parallel flow zones.

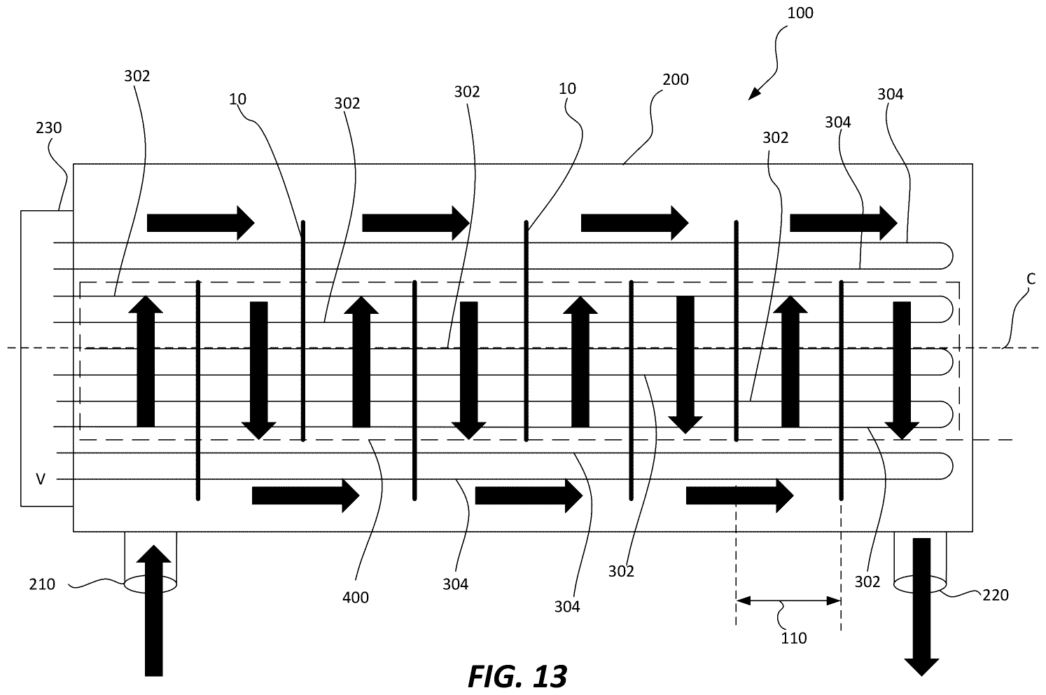

In the embodiment depicted in FIG. 13, the electric process heater 100 has an inlet 210 and an outlet 220 for the heat-transfer fluid to enter the vessel 200 and to exit from the vessel 200. The locations of the inlet and outlet are exemplary. The inlet and outlet may be located elsewhere in other variants. General directions of the flow of the heat-transfer fluid inside the vessel 200 are depicted by black arrows in FIG. 13. The black arrows show the general direction of flow in the crossflow zone inside the rectangle 400. The black arrows also show the general directions of flow in the parallel flow zone outside the rectangle 400. It will be appreciated that the arrows denote a general (main) direction of flow that intentionally neglects any eddy currents, turbulence, or localized fluid effects. In the embodiment of FIG. 13, the elongated heating elements include a first subset 302 of elongated heating elements in the crossflow zone and a second subset 304 of elongated heating elements in the parallel flow zone.

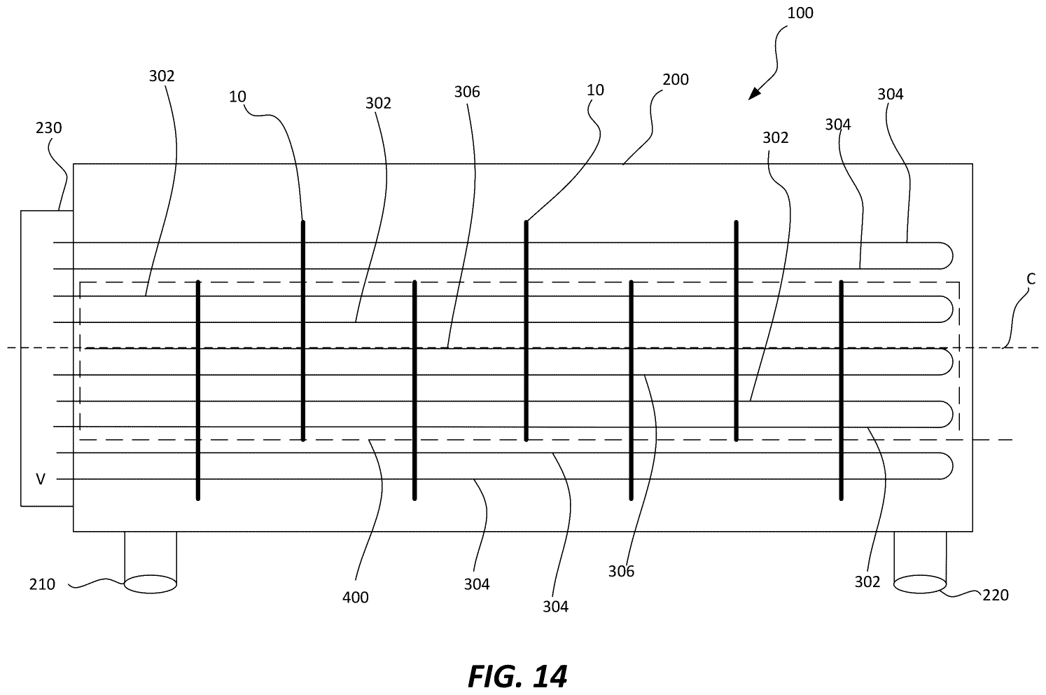

In the embodiment of FIG. 14, the elongated heating elements generate three different surface fluxes, i.e. three different watt densities. In other words, in the embodiment of FIG. 14, the elongated heating elements have three different heat-generating characteristics so that three different levels of heat are produced in different locations of the electric process heater. For example, in the specific embodiment of FIG. 14, the electric process heater 100 further comprises medium surface flux heating elements in addition to the higher surface flux heating elements and the lower surface flux heating elements. It will be appreciated that in other embodiments there may be four or more different surface fluxes. In FIG. 14, for example, there are three types of elongated heating elements, i.e. a first type (first subset) of elongated heating elements 302, a second type (second subset) of elongated heating elements 304 and a third type (third subset) of elongated heating elements 306. The first, second and third types of elongated heating elements may have three different levels of surface flux. For example, the first, second and third types of elongated heating elements may be characterized as high, medium and low surface flux. For example, one type of elongated heating elements may be used in a crossflow zone, another type may be used in a parallel flow zone and a third type may be used in a transitional flow zone, i.e. at a boundary of the crossflow zone and parallel flow zone.

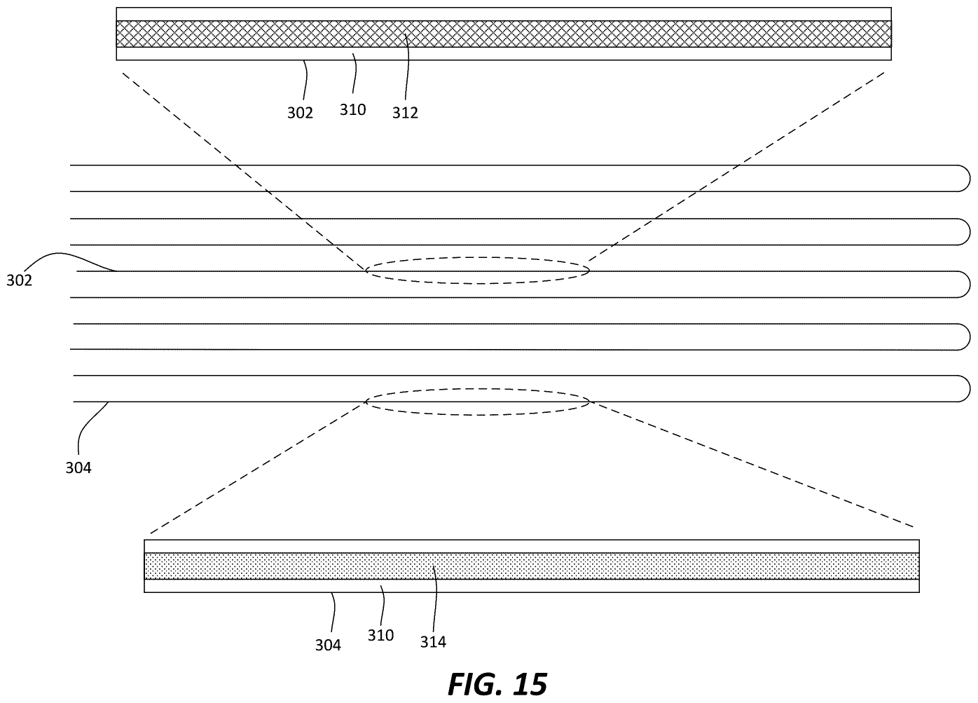

As depicted by way of example in FIG. 15, in some embodiments, the first subset 302 of elongated heating elements 302 has a higher electrical resistivity than the second subset 304 of elongated heating elements made of a second material. The first material thus produces more heat per unit length than the second material due to its higher resistivity as the same electrical current flows through the elongated heating elements. As shown in FIG. 15, an enlarged detail of one of the first subset 302 of elongated heating elements in the crossflow zone depicts an outer sheath 310 and the inner resistive wire that is made of a first material 312 having a first surface flux SF1. FIG. 15 also shows an enlarged view of one of the second subset 304 of elongated heating elements in the parallel flow zone. As shown in FIG. 15, an enlarged detail of one of the second subset 302 of elongated heating elements in the parallel flow zone depicts an outer sheath 310 and the inner resistive wire that is made of a second material 314 having a second surface flux SF2 that is different than the first surface flux SF1. The first subset 302 of elongated heating elements made of the first material thus generates more heat, i.e. has greater surface flux (watt density) than the second subset 304 of elongated heating elements made of the second material.

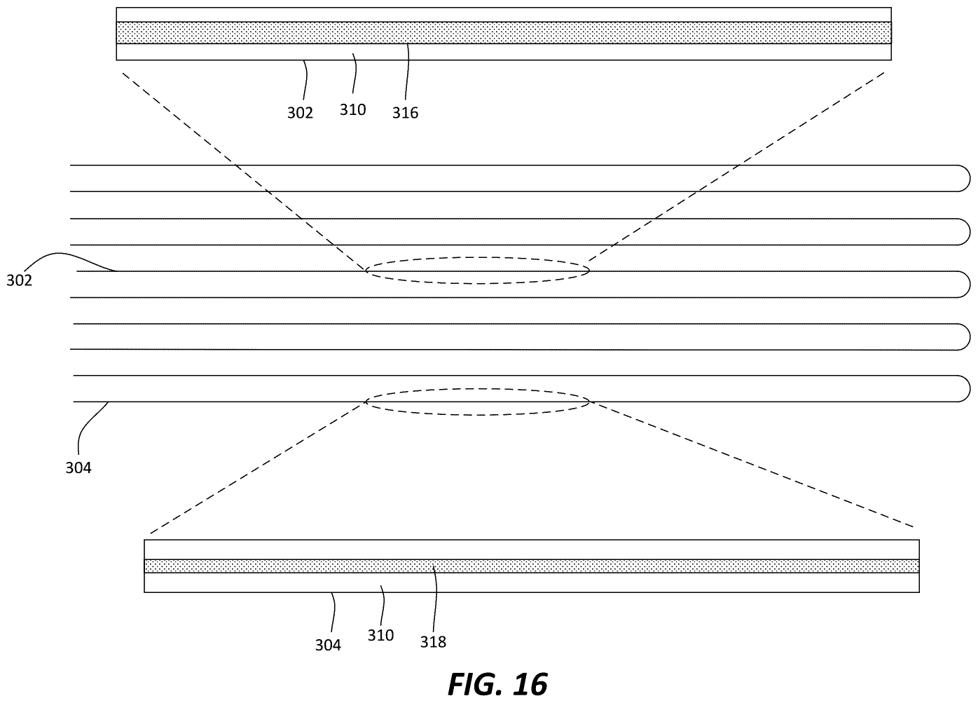

As depicted by way of example in FIG. 16, in some embodiments, the first subset 302 of elongated heating elements has a first wire gauge 316 whereas the second subset 304 of elongated heating elements has a second wire gauge 318. The first wire gauge produces more heat per unit length than the second wire gauge as the same electrical current flows through the elongated heating elements. As shown in FIG. 16, an enlarged detail of one of the first subset 302 of elongated heating elements in the crossflow zone depicts an outer sheath 310 and the inner resistive wire that is made of a first wire gauge 316 having a first surface flux SF1. FIG. 16 also shows an enlarged view of one of the second subset 304 of elongated heating elements in the parallel flow zone. As shown in FIG. 16, an enlarged detail of one of the second subset 302 of elongated heating elements in the parallel flow zone depicts an outer sheath 310 and the inner resistive wire that is made of a second wire gauge 318 having a second surface flux SF2 that is different than the first surface flux SF1. The first subset 302 of elongated heating elements made of the first wire gauge generates more heat, i.e. has greater surface flux (watt density) than the second subset 304 of elongated heating elements made of the second wire gauge.

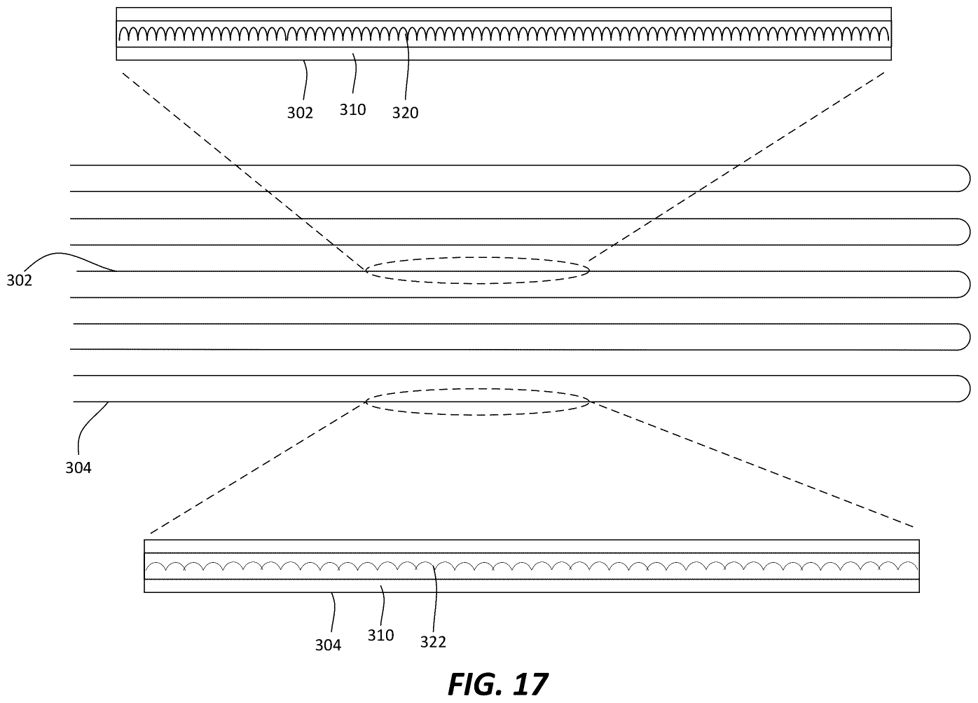

As depicted by way of example in FIG. 17, in some embodiments, the first subset 302 of elongated heating elements has a first coil pitch 320 whereas the second subset 304 of elongated heating elements has a second coil pitch 322. The first coil pitch produces more heat per unit length than the second coil pitch as the same electrical current flows through the elongated heating elements. As shown in FIG. 17, an enlarged detail of one of the first subset 302 of elongated heating elements in the crossflow zone depicts an outer sheath 310 and the inner resistive wire that has a first coil pitch 320 providing a first surface flux SF1. FIG. 17 also shows an enlarged view of one of the second subset 304 of elongated heating elements in the parallel flow zone. As shown in FIG. 17, an enlarged detail of one of the second subset 302 of elongated heating elements in the parallel flow zone depicts an outer sheath 310 and the inner resistive wire that has a second coil pitch 322 providing a second surface flux SF2 that is different than the first surface flux SF1. The first subset 302 of elongated heating elements having the first coil pitch generates more heat, i.e. has greater surface flux (watt density) than the second subset 304 of elongated heating elements having the second coil pitch.

In other embodiments, one or more of the elongated heating elements may be segmented into discrete segments having different heating properties so that each segment of a particular elongated heating element has distinct properties.

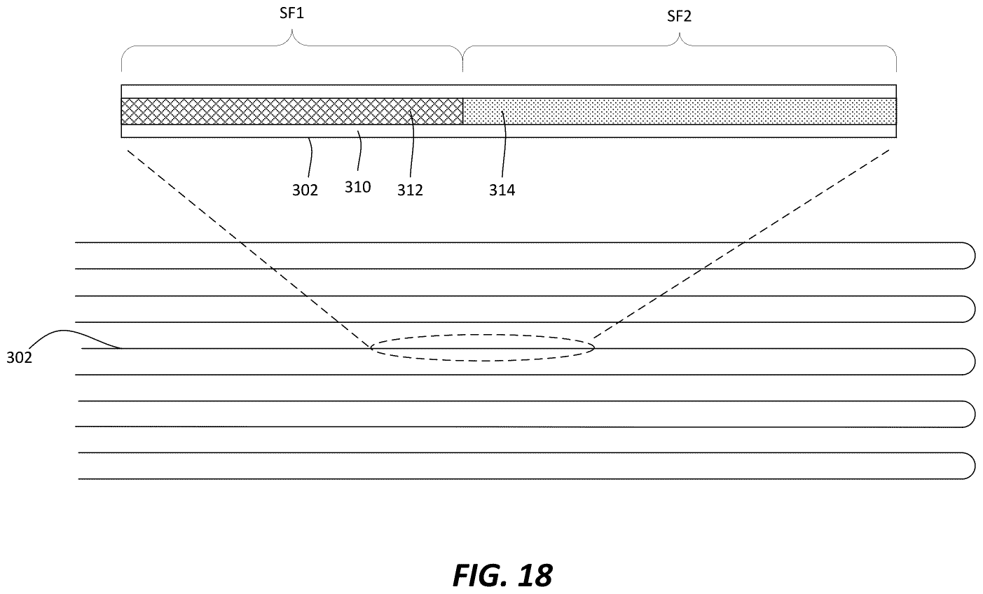

As depicted in the embodiment of FIG. 18, one of the elongated heating elements 302 of the first subset of elongated heating elements has a first segment made of first material 312 and a second segment made of a second material 314, wherein the first material generates more heat than the second material. The first segment made of the material 312 generates a first surface flux SF1 whereas the second segment made of the second material 314 generates a second surface flux SF2. The elongated heating element 302 may have a common sheath 310 enshrouding both segments as shown, or each segment may have its own sheath in a variant. Analogously, one of the elongated heating elements 304 of the second subset of elongated heating elements can have a first segment having a first material 312 and a second segment having a second material 314, wherein the first material generates more heat than the second material. This segmentation may be applied to one, some or all of the elongated heating elements of either the first subset or the second subset or to both the first and second subsets.

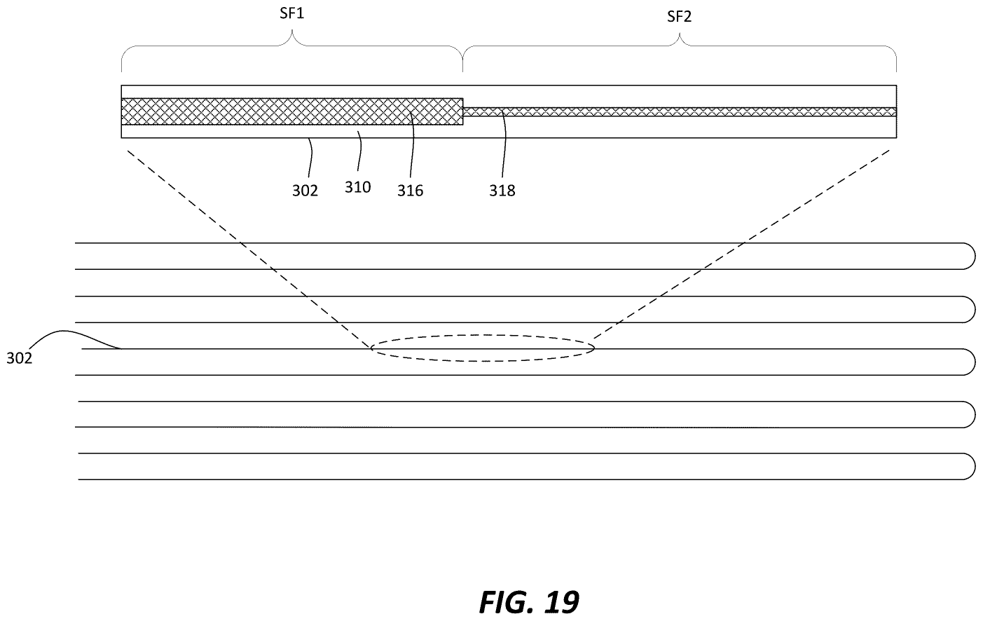

As depicted in the embodiment of FIG. 19, one of the elongated heating elements 302 of the first subset of elongated heating elements has a first segment having a first wire gauge 316 and a second segment having a second wire gauge 318, wherein the first wire gauge generates more heat than the second wire gauge. In this example, the difference in the wire gauges is visually exaggerated to illustrate the concept. The first segment having the first wire gauge 316 generates a first surface flux SF1 whereas the second segment having the second wire gauge 318 generates a second surface flux SF2. The elongated heating element 302 may have a common sheath 310 enshrouding both segments as shown, or each segment may have its own sheath in a variant. Analogously, one of the elongated heating elements 304 of the second subset of elongated heating elements can have a first segment having a first wire gauge 316 and a second segment having a second wire gauge 318, wherein the first wire gauge generates more heat than the second wire gauge. This segmentation may be applied to one, some or all of the elongated heating elements of either the first subset or the second subset or to both the first and second subsets.

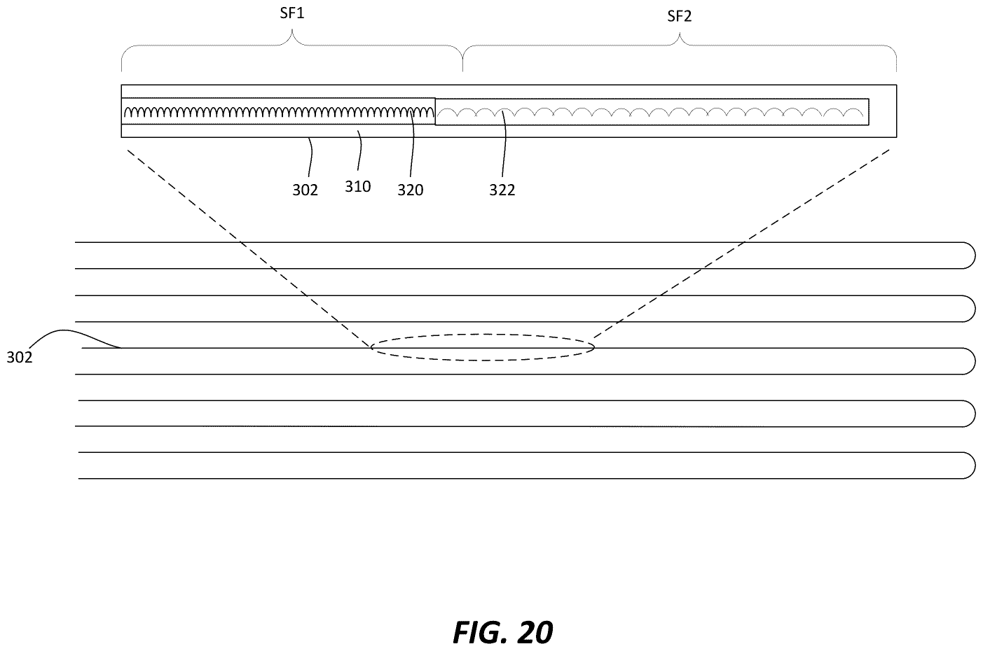

As depicted in FIG. 20, in other embodiments, one or more of the first subset of elongated heating elements 302 has a first segment having a first coil pitch 320 and a second segment having a second coil pitch 322. In one example, the first coil pitch generates more heat than the second coil pitch. In this example, the difference in the coil pitch is visually exaggerated to illustrate the concept. The first segment having the first coil pitch 322 generates a first surface flux SF1 whereas the second segment having the second coil pitch 324 generates a second surface flux SF2. The elongated heating element 302 may have a common sheath 310 enshrouding both segments as shown, or each segment may have its own sheath in a variant. Analogously, one of the elongated heating elements 304 of the second subset of elongated heating elements can have a first segment having a first coil pitch 322 and a second segment having a second coil pitch 324, wherein the first coil pitch generates more heat than the second coil pitch. This segmentation may be applied to one, some or all of the elongated heating elements of either the first subset or the second subset or to both the first and second subsets.

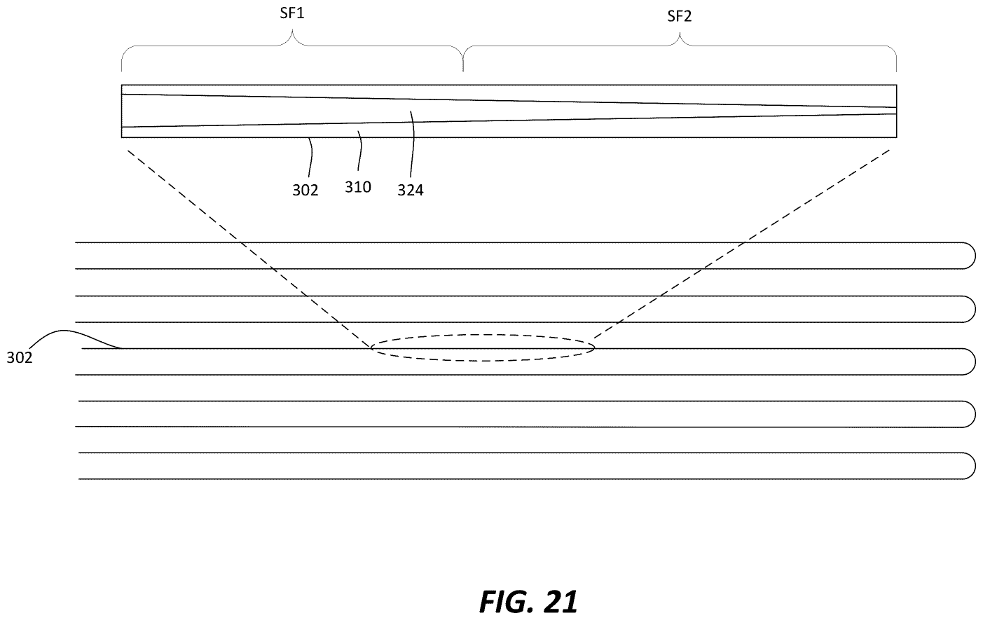

In the embodiment depicted in FIG. 21, one or more of the first subset of elongated heating elements 302 comprises a segment 324 of variable surface flux, i.e. a surface flux that varies along its length, either proportionately (linearly) or disproportionately (non-linearly). This segment 324 of variable surface flux may for example be a tapered gauge wire, a material whose properties change over its length and/or a coil pitch that varies over its length. Analogously, one or more of the second subset of elongated heating elements 304 may comprise a segment 324 of variable surface flux. In a variant, both the first and second subsets may comprise segments of variable surface flux.

In the embodiments described above, the higher surface flux is achieved by introducing a higher resistivity material, changing the wire gauge or changing the coil pitch. However, it will understood that any combination or subcombination of material, wire gauge and coil pitch may be used to provide differential surface flux. For example, in some embodiments, the first subset 302 of elongated heating elements may made of a different material, a different wire gauge and a different coil pitch than the second subset of elongated heating elements.

In some embodiments, the surface flux properties may be uniform for the elongated heating elements within the first subset. In other embodiments, the surface flux properties within the first subset of heating elements may vary. For example, in one embodiment, at least one of the first subset of elongated heating elements has a different surface flux than another one of the first subset of elongated heating elements. Analogously, the surface flux properties may be uniform for the elongated heating elements within the second subset. In other embodiments, the surface flux properties within the second subset of heating elements may vary. For example, in one embodiment, at least one of the second subset of elongated heating elements has a different surface flux than another one of the second subset of elongated heating elements.

In another aspect, an electric heater, e.g. an electric process heater such an immersion heater, includes a container or vessel containing a heat-transfer fluid such as water and a plurality of elongated heating elements extending inside the vessel. The plurality of elongated heating elements comprises a first subset of elongated heating elements having a higher surface flux than a second subset of elongated heating elements. Baffles are disposed inside the electric process heater. Baffles have holes through which the elongated heating elements extend. The heat-transfer fluid flows in a longitudinal flow zone where the fluid flows along the elongated heating elements and in a crossflow zone where the fluid flows between adjacent baffles across the elongated heating elements. The first subset of elongated heating elements is disposed in the crossflow zone and the second subset of elongated heating elements is disposed in the longitudinal flow zone. In one embodiment, the first subset of elongated heating elements has the higher surface flux than the second subset of elongated heating elements due to one or more of a higher resistivity material, a different coil pitch and/or a different wire gauge. In one embodiment, one or more of the elongated heating elements comprises segments having different surface flux.

In one embodiment, the crossflow zone is an inner cylindrical zone and the longitudinal flow zone is an outer annular zone that is concentrically disposed around the crossflow zone. The inventive concept may be applied to other geometries such that the crossflow zone and longitudinal flow zone are disposed in other ways.

In another aspect, a heater, e.g. an electric process heater, comprises a vessel containing a heat-transfer fluid and a plurality of heating elements, e.g. elongated heating elements extending inside the vessel, the plurality of elongated heating elements comprising higher surface flux heating elements and lower surface flux heating elements. A plurality of baffles is disposed inside the electric process heater and have holes through which the elongated heating elements extend. The heat-transfer fluid flows in a longitudinal flow zone where the fluid flows along the elongated heating elements and in a crossflow zone where the fluid flows between adjacent baffles across the elongated heating elements. The higher surface flux heating elements are disposed in the crossflow zone and the lower surface flux heating elements are disposed in the longitudinal flow zone.

In one embodiment, the higher surface flux heating elements in the crossflow zone have higher resistivity and/or have a different coil pitch and/or have a different wire gauge than the lower surface flux heating elements in the parallel flow zone.

One or more of the inventive features of the embodiments of FIGS. 12-21 may be used in conjunction with one or more of the inventive features of the embodiments of FIGS. 1-11. Alternatively, the one or more inventive features of the embodiments of FIGS. 12-21 may be used independently of the inventive features of the embodiments of FIGS. 1-11.

It is to be understood that the singular forms “a”, “an” and “the” include plural referents unless the context clearly dictates otherwise. Thus, for example, reference to “a device” includes reference to one or more of such devices, i.e. that there is at least one device. The terms “comprising”, “having”, “including”, “entailing” and “containing”, or verb tense variants thereof, are to be construed as open-ended terms (i.e., meaning “including, but not limited to,”) unless otherwise noted. All methods described herein can be performed in any suitable order unless otherwise indicated herein or otherwise clearly contradicted by context. The use of examples or exemplary language (e.g. “such as”) is intended merely to better illustrate or describe embodiments of the invention and is not intended to limit the scope of the invention unless otherwise claimed.

While several embodiments have been provided in the present disclosure, it should be understood that the disclosed systems and methods might be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the inventive concept(s) disclosed herein.

1. An electric process heater comprising:
a vessel containing a heat-transfer fluid;
a plurality of elongated heating elements extending inside the vessel parallel to a central axis of the electric process heater, the plurality of elongated heating elements comprising a first subset of elongated heating elements having a higher surface flux than a second subset of elongated heating elements; and
a plurality of baffles disposed at axial intervals inside the electric process heater to redirect a flow of the fluid over the elongated heating elements to provide improved heat transfer between the elongated heating elements and the fluid inside the vessel, wherein the flow comprises a parallel flow zone of parallel flow where the fluid flows parallel to the elongated heating elements and a crossflow zone of perpendicular flow where the fluid flows perpendicularly to the elongated heating elements, wherein the first subset of elongated heating elements having the higher surface flux is disposed in the crossflow zone and wherein the second subset of elongated heating elements is disposed in the parallel flow zone.

2. The electric process heater of claim 1 wherein the crossflow zone is an inner cylindrical zone and the parallel flow zone is an outer annular zone that is concentrically disposed around the crossflow zone.

3. The electric process heater of claim 1 wherein the first subset of elongated heating elements is made of a first material and the second subset of elongated heating elements is made of a second material, wherein the first material has a higher electrical resistivity than the second material.

4. The electric process heater of claim 1 wherein the first subset of elongated heating elements has a first wire gauge and the second subset of elongated heating elements has a second wire gauge, wherein the first wire gauge generates more heat than the second wire gauge.

5. The electric process heater of claim 1 wherein the first subset of elongated heating elements has a first coil pitch and the second subset of elongated heating elements has a second coil pitch, wherein the first coil pitch generates more heat than the second coil pitch.

6. The electric process heater of claim 1 wherein at least one of the first subset of elongated heating elements has a different surface flux than another one of the first subset of elongated heating elements.

7. The electric process heater of claim 1 wherein one or more of the first subset of elongated heating elements comprises a segment of variable surface flux.

8. The electric process heater of claim 1 wherein one or more of the first subset of elongated heating elements comprises segments having different surface flux.

9. The electric process heater of claim 1 wherein at least one of the second subset of elongated heating elements has a different surface flux than another one of the second subset of elongated heating elements.

10. The electric process heater of claim 1 wherein one or more of the second subset of elongated heating elements comprises a segment of variable surface flux.

11. The electric process heater of claim 1 wherein one or more of the second subset of elongated heating elements comprises segments having different surface flux.

12. An electric process heater comprising:
a vessel containing a heat-transfer fluid;
a plurality of elongated heating elements extending inside the vessel, the plurality of elongated heating elements comprising a first subset of elongated heating elements having a higher surface flux than a second subset of elongated heating elements; and
a plurality of baffles disposed inside the electric process heater and having holes through which the elongated heating elements extend, wherein the heat-transfer fluid flows in a longitudinal flow zone where the fluid flows along the elongated heating elements and in a crossflow zone where the fluid flows between adjacent baffles across the elongated heating elements, wherein the first subset of elongated heating elements is disposed in the crossflow zone and wherein the second subset of elongated heating elements is disposed in the longitudinal flow zone.

13. The electric process heater of claim 12 wherein the crossflow zone is an inner cylindrical zone and the longitudinal flow zone is an outer annular zone that is concentrically disposed around the crossflow zone.

14. The electric process heater of claim 12 wherein the first subset of elongated heating elements has the higher surface flux than the second subset of elongated heating elements due to one or more of a higher resistivity material, a different coil pitch and/or a different wire gauge.

15. The electric process heater of claim 12 wherein one or more of the elongated heating elements comprises a segment of variable surface flux.

16. The electric process heater of claim 12 wherein one or more of the elongated heating elements comprises segments having different surface flux.

17. The electric process heater of claim 12 wherein at least three of the plurality of elongated heating elements have at least three different surface fluxes.

18. An electric process heater comprising:
a vessel containing a heat-transfer fluid;
a plurality of elongated heating elements extending inside the vessel, the plurality of elongated heating elements comprising higher surface flux heating elements and lower surface flux heating elements; and
a plurality of baffles disposed inside the electric process heater and having holes through which the elongated heating elements extend, wherein the heat-transfer fluid flows in a longitudinal flow zone where the fluid flows along the elongated heating elements and in a crossflow zone where the fluid flows between adjacent baffles across the elongated heating elements, wherein the higher surface flux heating elements are disposed in the crossflow zone and wherein the lower surface flux heating elements are disposed in the longitudinal flow zone.

19. The electric process heater of claim 18 further comprising medium surface flux heating elements in addition to the higher surface flux heating elements and the lower surface flux heating elements.

20. The electric process heater of claim 18 wherein the higher surface flux heating elements have higher resistivity and/or have a different coil pitch and/or have a different wire gauge than the lower surface flux heating elements.
